(19) United States
(12) Patent Application Publication
(10) Pub. No.: US 2007/0024658 A1
(43) Pub. Date: Feb. 1, 2007

(54) Apparatus and method for detection of liquid droplets

(75) Inventors: Sabrina J. Diol, Pittsford, NY (US); Michael S. Ferschl, Webster, NY (US); James R. Kircher, Mendon, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/191,852

(22) Filed: Jul. 28, 2005

(51) Int. Cl. B41J 29/393

(52) U.S. Cl. 347/19

(57) ABSTRACT

An ink jet printer comprising an ink jet print head having at least one row of a plurality of ink ejecting ports for ejecting ink droplets along a plurality of ink droplet paths, the ink jet print head residing at a first elevation; a collimated light source and a detector each residing at a second elevation that is lower than the first elevation, the detector positioned opposite the collimated light source, the ink jet print head being movable to a test position where the at least one row of a plurality of ink ejecting ports can fire non-printing droplets, the collimated light source directing light at the detector along a light path that intersects the plurality of ink droplet paths when the print head resides in the test position; and an aperture located in between the collimated light source and detector and proximate to the detector to limit a field of view of the detector and increase an optical signal-to-noise ratio of the detector.

### FIELD OF THE INVENTION

The present invention relates generally to monitoring the performance of liquid ejection ports, and more particularly, to an apparatus and method for monitoring the performance of ink ejection ports in ink jet printers.

### BACKGROUND OF THE INVENTION

An ink jet printer produces images on a receiver by ejecting ink droplets onto the receiver. The receiver is the media (e.g., paper, fabric, etc.) on which the printing is performed. Ink jet printing devices, (e.g., printers, photocopiers, facsimile machines, etc.), typically house a print head with ejection ports, often referred to as nozzles, that fire drops of ink onto a receiver. The advantages of non-impact, low-noise, low energy use, and low cost of operation, in addition to the capability of the printer to print on plain paper, are largely responsible for the wide acceptance of ink jet printers in the marketplace.

Ink jet print heads include ejection ports on a nozzle plate through which the ink drops are fired. The particular ink ejection mechanism within the print head may take on a variety of different forms as known to those skilled in the art, such as those using piezoelectric technology or thermal inkjet technology. To print an image, the print head is scanned back-and-forth across a print zone above the receiver. As the print head moves in translation, the ejection ports fire drops of ink. By selectively firing ink through the ejection ports of the print head, the ink is expelled in a pattern on the print media to form a desired image. The ejection ports are typically arranged in one or more linear arrays along the print head. The print heads are usually housed in a carriage, which scans back and forth over the media. During the printing process, the media is advanced under the scanning print head to enable printing over the desired area of the receiver.

It is known that high quality printing by an ink jet printer requires repeated ejection of ink droplets from the ejection ports nozzles on the print head. However, ejection ports may malfunction for a variety of reasons. For example, the nozzle plate may collect contaminants such as dust fibers over time. These contaminants may adhere to the orifice plate either due to the presence of ink on the print head, or due to electrostatic charges. In addition, excess ink may also accumulate and dry on the nozzle plate. Ink, at the orifice of exposed ejection ports, may lose moisture if those ports are not utilized even for a short duration of time. This may occur, for example, at ejection ports that are not required during a particular print. Factors such these interfere with the desired performance of some ejection ports causing ejected droplets to not have the desired physical characteristics. Some poorly performing nozzles may eject ink droplets that have an incorrect volume, causing the dots produced on the page to be of an incorrect size. Other mal-performing nozzles may eject drops with an improper velocity or trajectory, causing them to land at incorrect locations on the media. Additionally, some mal-performing nozzles may completely fail to eject any ink droplets at all. When such mal-performing nozzles are present, undesirable lines and banding artifacts will appear in the printed image, thereby degrading image quality.

For at least these reasons, it is desirable to determine which ejection ports are mal-performing so as to enable operations to maintain image quality and throughput. These operations include servicing routines and the “exercise” of well-performing ejection ports. Determination of the firing condition of the ejection ports is usually performed with a drop detector. It is known to attempt drop detection as the ink drop leaves the ejection port during normal operation. This is usually performed with a drop detection sub-system of the printer located in proximity to the print zone. When in use, the print head is controlled to travel over the drop detector so as to align a row of ejection ports over the drop detector. Typically, each ejection port is fired and the ensuing ink drop or the lack thereof detected. Usually the print head is repositioned to align remaining rows over the drop detector and this process is repeated until all ejection ports have been verified.

It is known to rely on optics to detect ink drops. For example, in U.S. Pat. No. 5,304,814 to Markham there is taught a method for detecting the presence of ink from a thermal ink ejecting print head. In such a drop detector design, a light source and a light detector are configured such that the path of light intercepts the flight of the ink drop. The light source could be in the form of a light emitting diode (LED) and the light detector a photo diode. The light emitted by the LED is typically collimated by a lens to produce a narrow, substantially parallel beam. The photo diode reacts to impinging light by producing a current, which is subsequently amplified by an amplifier. Typically the photo diode feeds back to the LED to maintain a constant current output from the photo diode. In the event of obstruction of the beam of light, as would occur with the flight of an ink drop, a decrease in the output current of photo diode would result in an increased current to the LED to increase the brightness of emission. The resulting signal from the photo diode is sampled and electrically processed to determine the presence and characteristics of the ink drops. Further, in order to obtain a clear signal of the ink drop, the ejection port is typically commanded to fire several drops numerous times to obtain an average signal.

Though such drop detection is clearly desirable to maintain image quality of the printer, the time required to perform the drop detection increases the total time required to print an image, thereby reducing productivity. Further, improvements in ink jet head design and manufacture have created a trend to increase the number of ejection ports to a linear density of more than 1000 per inch. Improvements have also led to the capability to fire drops of lower volumes in the range of 1 to 10 picoliters (pL). Hence, it is desirable to achieve drop detection of these low volume drops with high signal to noise and a consequently shorter detection time. Additionally, a high signal to noise drop detector would utilize fewer drops to achieve drop detection and reduce ink waste.

### SUMMARY OF THE INVENTION

An object of the present invention is to provide a method and apparatus to detect small volume ink drops with high signal to noise in order to efficiently detect the condition of ejection ports of an ink jet print head. In this case, efficiency refers to the use of time and ink with respect to the productivity of the printer. Such detection will enable the subsequent implementation of measures to maintain image quality. Measures to reactivate a non-functional or correct a malfunctioning ejection port may include spitting, purging, wiping, or other maintenance routines, or combinations thereof. In the event that maintenance routines fail to reactivate a non-functional or correct a malfunctioning ejection port, other methods can be employed to reduce or prevent degradation of the quality of the printed image such as using a redundant nozzle, or using a print mask that effectively hides the error.

According to a first aspect of the present invention there is provided an ink jet printer comprising an ink jet print head having at least one row of a plurality of ink ejecting ports for ejecting ink droplets along a plurality of ink droplet paths, the ink jet print head residing at a first elevation; a collimated light source and a detector each residing at a second elevation that is lower than the first elevation, the detector positioned opposite the collimated light source, the ink jet print head being movable to a test position where the at least one row of a plurality of ink ejecting ports can fire non-printing droplets, the collimated light source directing light at the detector along a light path that intersects the plurality of ink droplet paths when the print head resides in the test position; and an aperture located in between the collimated light source and detector and proximate to the detector to limit a field of view of the detector and increase an optical signal-to-noise ratio of the detector. The increase in the optical signal-to-noise ratio of the detector allows for detection of ink droplets having a volume of as small as 1 picoliter.

Preferably the light source operates in an infrared wavelength such that ink droplets of different colors provide a signal that is independent of an individual ink droplet spectral response. As ink jet printers typically print with a plurality of inks of different colors, such as black, cyan, magenta and yellow, the ink drop detector should function independently of spectral response. Preferably the light source operates in an infrared wavelength that is generally transparent to ink droplets of different colors. Preferable light sources are high intensity and narrow irradiance light emitting diodes (LEDs), laser diodes, and vertical cavity surface emitting lasers (VCSELs). Collimation of light, if needed, can be achieved through the use of a collimating lens after the light source for LEDs and laser diodes.

According to a second aspect of the present invention there is provided an ink jet printer comprising an ink jet print head having at least one row of a plurality of ink ejecting ports for ejecting ink droplets toward a receiver along a plurality of ink droplet paths, the ink jet print head residing at a first elevation; a linear detection array positioned at a second elevation lower than the first elevation and parallel to the at least one row of a plurality of ink ejecting ports; and a linear light source positioned at the second elevation beneath and parallel to the at least one row of a plurality of ink ejecting ports, the linear light source located opposite the linear detection array, the ink jet print head capable of being moved to a test position where the at least one row of a plurality of ink ejecting ports can fire droplets, the linear light source directing light in a light path that intersects the ink droplet paths when the ink jet print head is moved to the test position.

According to a third aspect of the present invention there is provided a method for detecting liquid droplets fired from at least one ejector, the method comprising positioning the ejector at a test position; ejecting liquid droplets along at least one droplet path from the at least one ejector while the ejector is in the test position; directing collimated light toward a detector in a light path that intersects the at least one liquid droplet path; and restricting a field of view of the detector with an aperture proximately located to the detector thereby increasing an optical signal-to-noise ratio of the detector.

### BRIEF DESCRIPTION OF THE DRAWINGS

FIG. 1 is a perspective schematic of an optical drop detection system having a light path between an emitter and light detector, which can be intersected by ink drops ejected from an ink jet print head.

FIG. 2a front elevational view of one example of an aperture structure located in front of the light detector.

FIG. 2b perspective view of the aperture structure shown in FIG. 2a.

FIG. 2c side elevational view of detector and aperture of FIG. 2a indicating the proximity of the aperture to the detector.

FIG. 3 is a graph plotting signal (in volts) versus time (in ms) illustrating signal-to-noise data for a detection system such as shown in FIG. 1 with no aperture, a detection system with a 0.5mm aperture, and a detection system with a 1.5 mm aperture.

FIG. 4 is a perspective schematic of an alternative optical drop detection system having multiple detection light paths aligned in parallel to intersect the path of flight of ink drops.

FIG. 5a is a front elevational view of an alternative embodiment of an aperture structure that creates multiple detection areas on a single light detector.

FIG. 5b is a perspective schematic of the optical drop detection system shown in FIG. 1 substituting the alternative embodiment aperture structure of FIG. 5a therein.

FIG. 6 is a schematic depiction of a linear illumination bar and a corresponding detector array for use determining deviation of the ink drop from the desired path of flight along the direction of the row of print head ejection ports.

FIG. 7 is an exemplary circuit diagram of an inkjet drop detector that can be used to produce a pulse width that is related to the size and speed of an ink drop.

FIG. 8 is a graph plotting voltage versus time showing the waveforms produced by the circuit shown in FIG. 7.

FIG. 9 is a perspective view of one embodiment of a drop detector sub-system of the present invention.

FIG. 10 is a perspective view of a print head carriage over the platen of a printer with the drop detector sub-system of FIG. 9 mounted in the printer.

FIG. 11 is a perspective schematic depiction of the drop detector sub-system of FIG. 9 with the detector wired to communicate with the signal processor(s) of the printer.

FIG. 12 is a perspective view schematically illustrating one embodiment of a drop detector sub-system mounted on a flexible circuit.

### DETAILED DESCRIPTION OF THE INVENTION

Inkjet print engines enable printing via ejection of droplets of ink from ejection ports or nozzles onto a desired receiver. In order to maximize printing efficiency and image quality, it is critical to assess the performance of these ejection ports. This can be achieved by monitoring the characteristics of the ejected drops. For example, the absence of a drop could indicate a failure to fire the ejector or need for servicing. Another example that could indicate poor performance of the particular ejector is low velocity for an ejected drop.

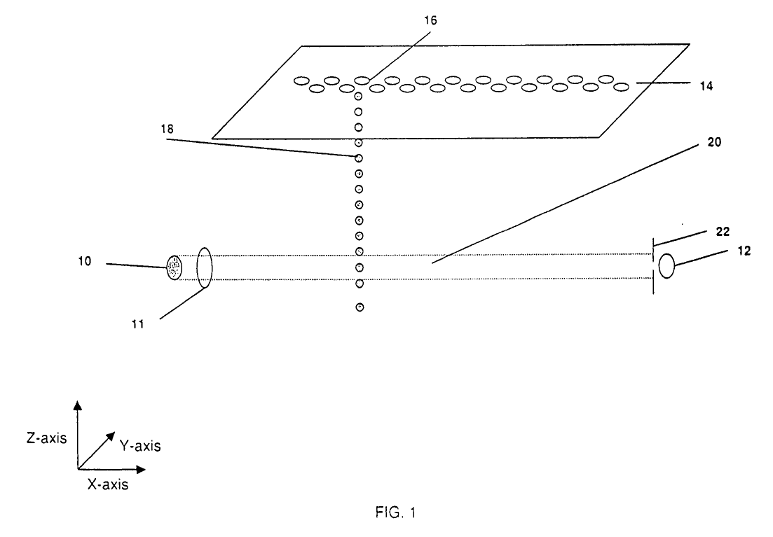

The present invention employs optical drop detection. A path of light, also referred to as the detection zone, is produced with a suitable emitter or light source and directed to impinge upon a detector. A row of ejector ports is aligned substantially parallel to this path of light such that the ejected drops pass through and intercept the path of light. The momentary partial obstruction of light is detected, thereby achieving detection of the drop. As illustrated in FIG. 1, a collimated light source 10 and detector 12 are positioned under and parallel to the plurality of ejecting ports 14. A particular ejection port 16 is directed to fire ink drops 18 which will intersect the detection zone 20 between collimated light source 10 and detector 12. The ink drops are finally collected in a receptacle or suitable absorbing material such as foam or felt (not shown).

With continuing improvements in ejector technology, ink droplets are being generated with smaller volumes e.g. 1-10 pL. The present invention enables the detection of these small volume droplets through the use of an aperture structure 22 proximately located to the detector 12 so as to limit the field of view of the detector 12 and increase the optical signal-to-noise ratio of the detector 12. In the preferred embodiment, an aperture 22 perpendicular to the direction of the plurality of ejectors and parallel to the path of motion of the ink jet head will achieve the desired increase signal-to-noise without impacting the positioning requirements of the print head.

When an ink drop 18 traverses the path of light or detection zone 20, the ink drop 18 interacts with the light through two mechanisms, namely, absorption of light and scattering of light. Utilizing both mechanisms will increase the signal-to-noise ratio for detection of the ink drop 18. However, relying on absorption of light is not desirable as the spectral response of the ink drop 18 will change based on ink formulation. Therefore, in order to avoid absorption, the light source 10 should operate in infrared wavelengths, preferably with high intensity and narrow irradiance. As light scattering is dependent on the size of the scatter and not the chemical composition, such a light source 10 will enable consistent detection of ink drops 18 independent of ink color. There are various available light sources 10 operating in this optical range such as, for example, light emitting diodes (LEDs), vertical cavity surface emitting lasers (VCSEL), and laser diodes. To simplify detection, it is also important for the path of light to remain collimated in the detection zone 20. This enables detection to remain consistent along the length of the detection zone 20 such that ink drops 18 ejected from any ejection port 14 will yield the same signal. Collimation of light, if needed, can be achieved through the use of a collimating lens 11 positioned after the light source. Alternatively, a light source that generates collimated light can be used, such as a VCSEL.

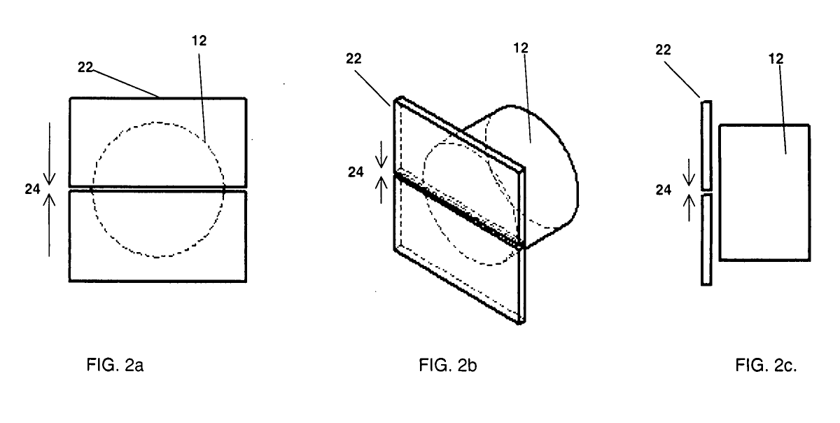

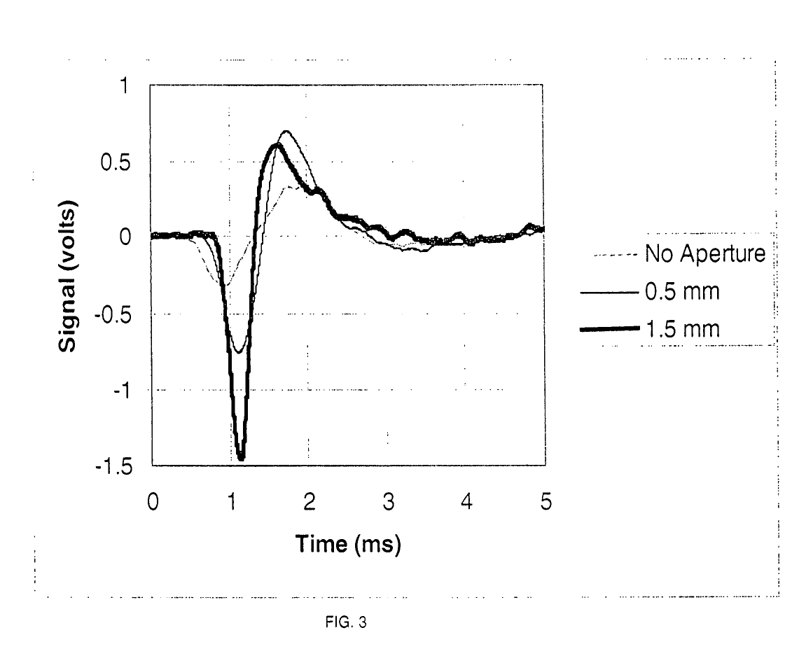

The most critical element in the optical design of the drop detector of the present invention is the aperture structure 22 proximately located to the detector 12, as illustrated in the enlarged schematic of FIG. 2. The aperture 22 limits the field of view of the detector 12 to a narrow slit 24 which results in an increased optical signal-to-noise of the detector 10 as illustrated by the graph in FIG. 3. There is a delayed response in the feedback between the detector 12 and the emitter 10 resulting in an over shoot in the output current of the detector 12, which is indicated in each of the three cases illustrated in FIG. 3. FIG. 3 illustrates the effect of apertures of size 0.5 mm and 1.5 mm on the peak-to-peak amplified signal response. Apertures having a width in the range of from about 0.1 to about 2 mm serve the purpose of significantly boosting the signal-to-noise ratio (SNR) to a range of 1.5:1 to 10:1. This increased signal-to-noise enables detection of small volume drops down to 1 pL. For the purpose of this invention, a standard normal distribution is assumed for noise. The noise is defined as four times the standard deviation (4σ) of the signal obtained in the absence of ink drops. The signal is defined as the peak-to-peak amplitude obtained in the presence of ink drops. As SNR is often measured in decibels (dB), the following equation yields the decibel equivalent of changes in SNR achieved with the present invention:
SNR (dB)=20 log₁₀ (peak-to-peak signal voltage/root-mean-squared noise voltage)

The use of apertures of width from about 0.1 to 2 mm improves SNR to a range of 3 to 20 dB.

Improvement in signal-to-noise can also be achieved by firing multiple ink drops from a given ejection port and averaging the detection response. This averaging builds up the signal while reducing the noise. However, such averaging also results in an increase in the overall detection time and lowered printer productivity. With the present invention, the increased signal-to-noise from the use of apertures can be utilized to reduce or eliminate signal averaging, which will lower drop detection time and hence increase the efficiency of the detection process. A further benefit of the enhanced signal-to-noise is reduced waste of ink for drop detection as fewer ink drops are utilized for detection.

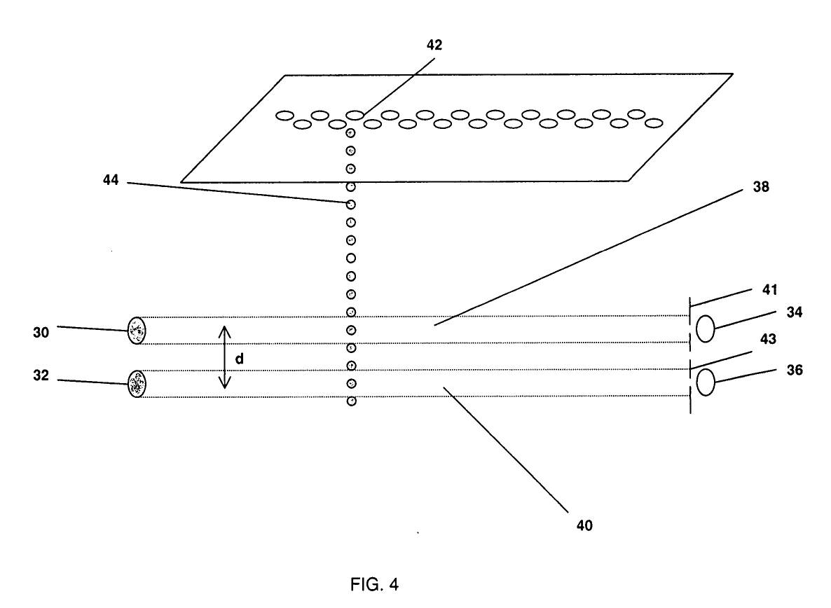

The use of multiple and/or alternate light sources and detectors can be used to further expand the capabilities of the drop detector to capture additional information regarding the ink drops. An alternative embodiment of the present invention employing multiple light sources and multiple detectors is schematically depicted in FIG. 4. There is a first collimated light source 30 and a second collimated light source 32 that are operated in conjunction with a first detector 34 and a second detector 36, respectively, resulting in a first detection zone 38 and a second detection zone 40. The orientation of the first and second collimated light sources 30, 32 and the first and second detectors 34, 36 are positioned under and parallel to the plurality of ejecting ports 42. There are aperture structures 41, 43 proximately located to the detectors 34, 36, respectively, so as to limit the field of view of the detectors 34, 36 and increase the optical signal-to-noise ratio of the detectors 34, 36. As shown one particular ejection port 42 is directed to fire ink drops 44 that intersect both the first and second detection zones 38, 40. The second detection zone 40 not only allows for the recording of the traversal of the ink droplet 44 therethrough, but also allows for the recording of the time difference, Δt, with respect to the first detection zone 38. Using the distance between apertures, d, the speed of the drop, S, can be computed from:
S=d/Δt

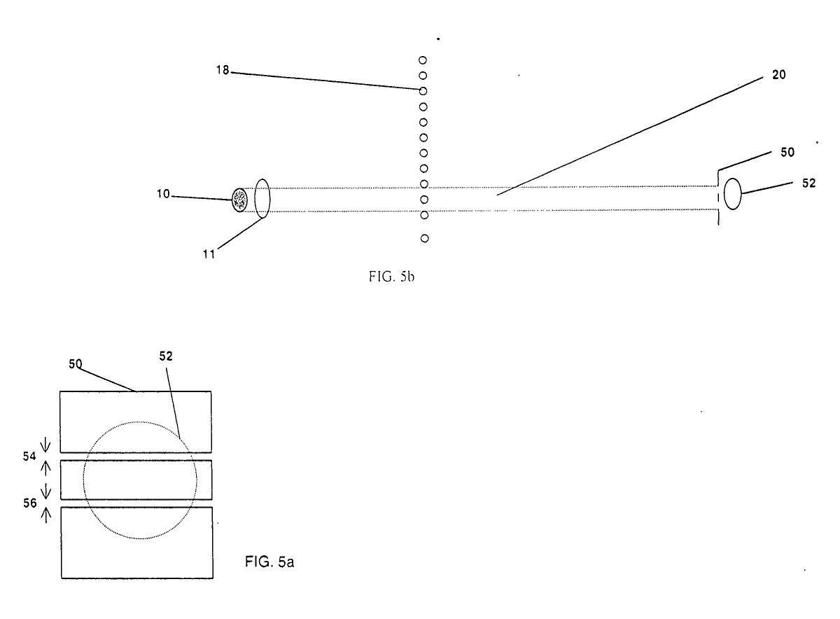

An alternative to using first and second collimated light sources 30, 32 and the first and second detectors 34, 36 to create first and second detection zones 38, 40 is shown in FIG. 5. The same information can be obtained with a double-slit aperture structure 50 placed over the area of the detector 52. The two slits are shown as 54 and 56. Such a configuration is desirable as it utilizes fewer parts, which lowers cost and complexity. Alternate detectors such as 2-dimensional charge coupled devices (CCD), or 2-dimensional complementary metal oxide semiconductor detectors (CMOS) can also be utilized. The latter offers a low cost solution and is particularly suitable as required detector elements can be individually addressed. Such detectors would be matched with similar dimensional light sources to provide the necessary detection zone.

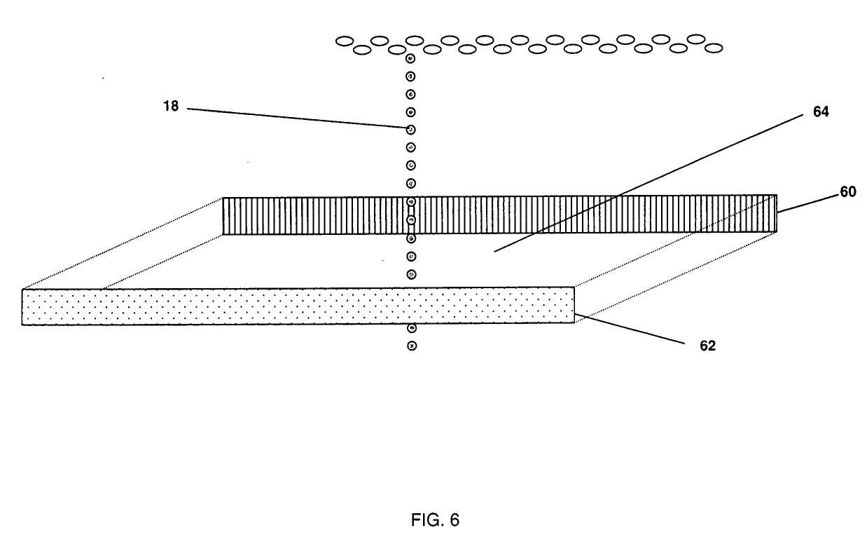

Another physical characteristic of the ink drop that is relevant to the image quality in printing is deviation from the desired path of flight. Such deviations, if gross enough, will cause the ink drop to land and thereby print on the receiver at an inappropriate location. This may lead to image quality degradation resulting from printing of ink on white areas, excessive application of ink in certain areas or the application of incorrect colors. The use of 2-dimensional detectors, as mentioned above, and/or 1-dimensional detectors allows for determination of deviation of the ink drop from the desired path of flight. Examples of 1-dimensional detectors are linear arrays (CCD or CMOS). As this deviation can occur in 2-dimensions, it is relevant to record both of these. FIG. 6 illustrates one application of such detectors in conjunction with the optical drop detection system depicted in FIG. 1. Here, a linear array 60, illuminated by a linear illumination bar 62, is positioned parallel to the detection zone 64, which consists of a parallelepiped defined by the geometry of the illumination bar 62 and linear array 60. One example of a linear illumination bar 62 is a linear array of adjacent fiber optics forming a line of point light sources. The field of view of the linear array 60 will allow the recording of the ink droplet 18 and any deviation of the flight path of the ink droplet 18 along the direction of the linear array 60. Similarly, in another embodiment, the deviation of the droplet 18 in a direction that is perpendicular to the direction of the detection zone 64 can be recorded by a linear array (not shown) at the end of the detection zone 64. In yet another embodiment, this deviation can be recorded by a 2-dimensional detector (not shown) at the end of the detection zone 64.

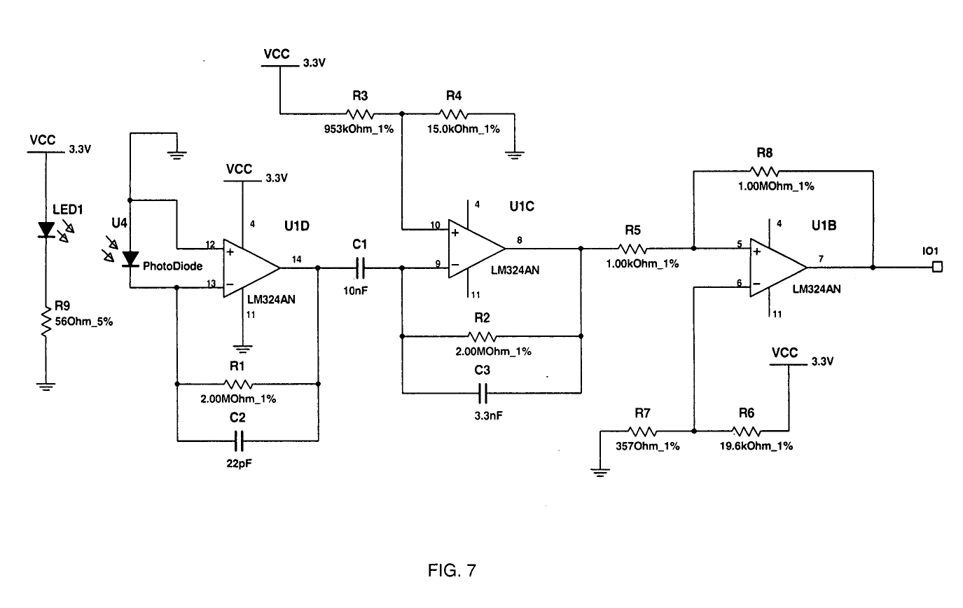

In yet another aspect of the present invention, the analog signal produced by an inkjet drop passing through an optical beam can be converted to a pulse width that can be measured by standard electronics. The width of this pulse is proportional to the size and speed of the inkjet drop passing through the optical beam. FIG. 7 shows a circuit diagram of an inkjet drop detector that produces a pulse width which is related to the size and speed of an inkjet drop passing through an optical beam produced by the LED and received by the photodiode. Referring to FIG. 7, the light emitted by LED1 travels to photodiode U4 as a beam of light. Operational Amplifier (Op Amp) U1D, receives the signal from Photodiode U4 and amplifies it. The output of Op Amp U1D is further amplified and is also inverted by Op amp U1C. The output of Op Amp U1C is converted into a pulse by Op Amp U1B, which has been configured as a comparator. As previously mentioned, Op Amp U1C amplifies the signal from Op Amp U1D. To help eliminate noise from the circuit, Op Amp U1C will only amplify signals above a selected voltage threshold. This voltage threshold is determined by the resistor divider network of R3 and R4. The voltage threshold is selected to be high enough to ignore spurious noise, but low enough to allow a legitimate signal to pass and be amplified. For the circuit shown, a voltage threshold of 0.05 volts was selected. Op Amp U1B also has a resistor divider network to help it reject noise and process only the signal from Op Amp U1C. This resistor divider network consists of resistors R6 and R7. These resistors combine to produce a voltage threshold of 0.06 volts. Signals above 0.06 volts will be converted to a pulse having an amplitude that is very close to the supply (Vcc) voltage of 3.3 volts.

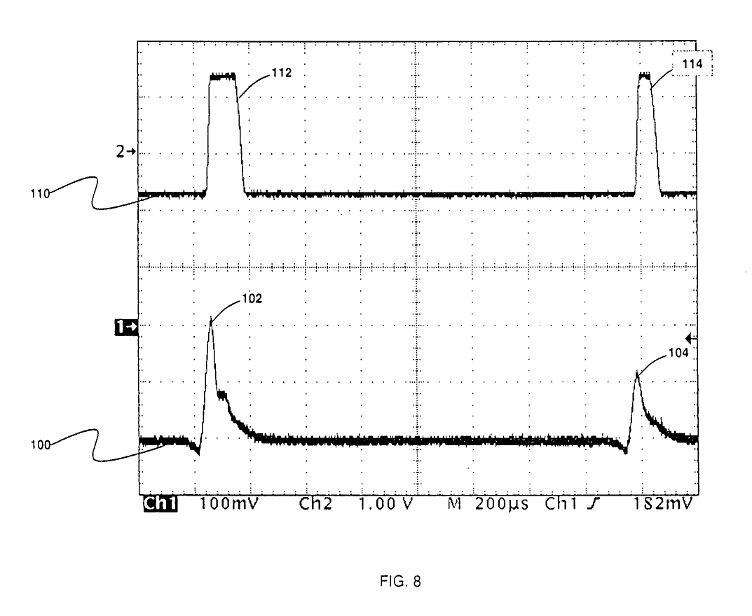

Referring to FIG. 8, the lower trace 100 is the output of Op Amp U1C and shows two peaks 102, 104. These peaks 102, 104 are representative of two inkjet drops that are passing through the optical beam produced by the circuit of FIG. 7. In FIG. 8, it can be seen that the left peak signal 102 is higher than the right peak signal 104. This is because a large volume inkjet drop is passing through the optical beam of the circuit of FIG. 7, followed by a smaller ink drop.

Again referring to FIG. 8, the upper trace 110 is the output of Op Amp U1B, which has been configured as a comparator. When the output signal level of Op Amp U1C is above the voltage threshold of 0.06 volts, the comparator produces an output pulse, which approaches the Vcc voltage of 3.3 volts. It can be seen in FIG. 8 that the upper trace 110 has two pulses 112, 114 produced by the signal shown in the lower trace 100. It can also be seen that the pulse width of the left pulse 112 is wider that the pulse width of the right pulse 114. Again this is because a higher volume ink drop is passing through the optical beam of the circuit in FIG. 7, followed by a smaller ink drop.

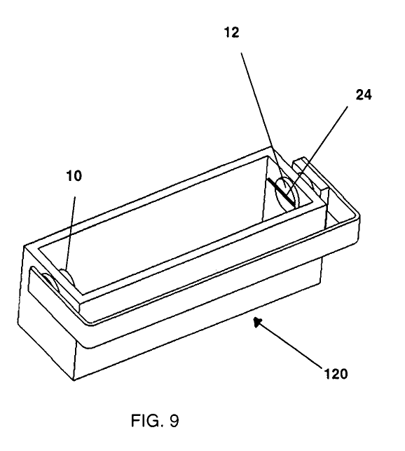

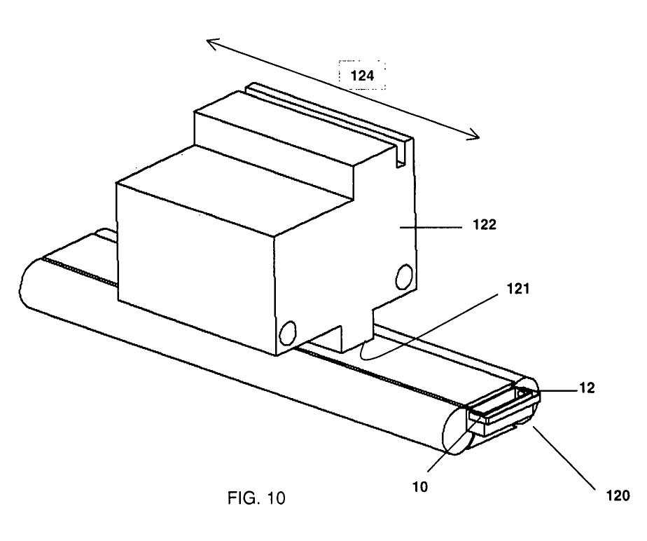

The drop detector sub-system 120 is preferably a self-contained unit as shown in FIG. 9. The location of the drop detector sub-system 120 containing, for example, the collimated light source 10 and detector 12 (shown in FIG. 1) within a printer is illustrated in FIG. 10. This partial view of a print head carriage over the platen of an ink jet printer indicates the drop detector 120 is located next to the print zone in proximity to the capping and servicing station for the print head 121. The carriage bearing the heads is shown as 122 with substantially translational motion possible along axis shown as 124. The drop detector sub-system 120 is fixed with respect to the printer such that the print head moves to position at least one row of a plurality of ink ejecting ports to intersect with the path of light or detection zone 20 (see FIG. 1), defined by the emitter 10, detector 12, and the aperture structure 22. This enables the use of as few as one emitter-detector pair to record ink drop information for all ejection ports. The drop detector subsystem is preferably located proximate to ink jet printer maintenance station.

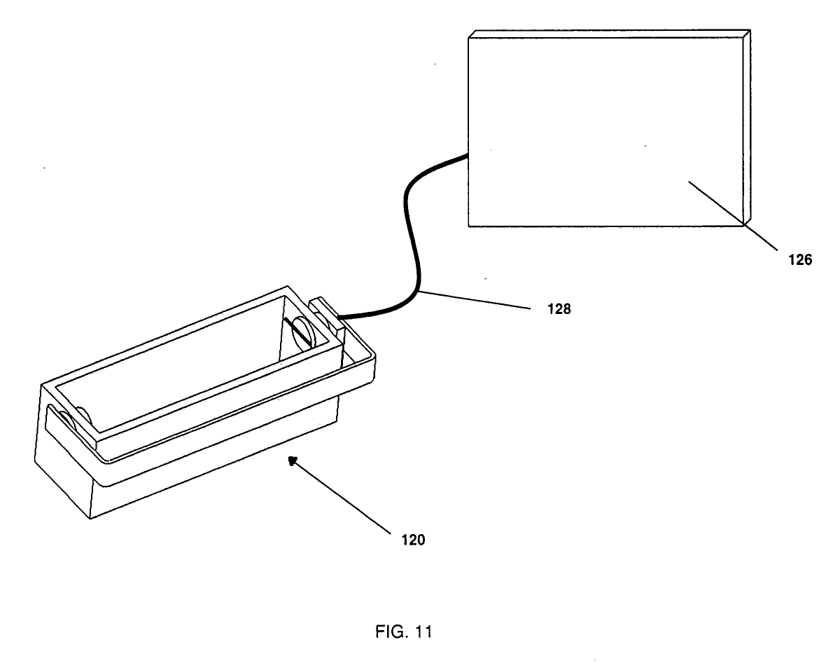

The above descriptions provide schemes to record a variety of physical characteristics of ink drops relevant to image quality. Implementation of these schemes requires the use of electrical hardware. It is possible to manufacture a largely independent sub-system for drop detection. However, cost and design complexity increase as a consequence. Referring to FIG. 11, one efficient implementation involves transmission of analog signal output from the detector sub-system(s) 120 to a signal processor residing on, for example, the mother board 126 of the printer by means of an electrical cable 128. Such signal processors are already resident in the printer to enable the operation of the detector sub-system(s) 120. For example, the processors serving the central processing unit (CPU) of the printing device can be used for this purpose. Another advantage of such an implementation is reduced time for drop detection as signals generated by the detector are converted at a rate limited by the processing speed of the signal processor of the printer. Signals generated by the detector are converted at a rate that exceeds a firing rate of the ink ejecting ports. This reduced time for drop detection increases the efficiency for drop detection as well as efficiency of the printing process.

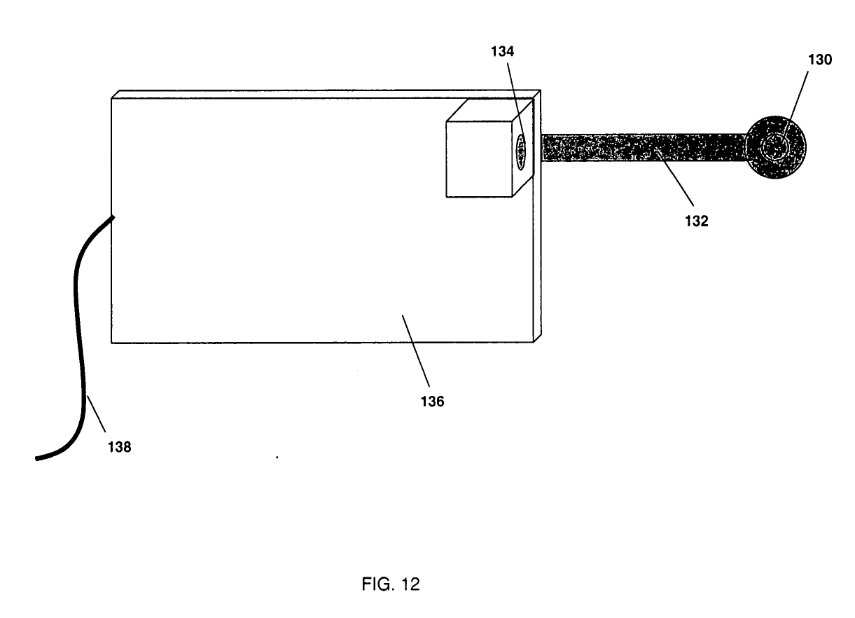

FIG. 12 illustrates a further embodiment of the present invention where the drop detector is mounted on a flexible circuit. The emitter 130 is located on a flex cable 132, which electrically communicates with the detector 134 and the associated electronics, as illustrated in FIG. 7, mounted on board 136. Electrical communication with the main processor of the printer is shown as line 138 for purposes of powering and other signal processing. Such a drop detector unit is then mounted to a printer chassis with capture features (not shown) for positioning the drop detector 134 and built-in apertures (not shown). The capture features of the printer position the emitter 130 and detector 134 to create the detection zone in the required physical location, just outside the print zone and in proximity to the maintenance and capping station of the printer. The capture features may further be designed with apertures and/or elements to collimate and/or collect light. Such adaptation of the chassis manufacturing to accommodate the sub-system for drop detection reduces the number of parts necessary for drop detection. This leads to ease of manufacture and lower cost and complexity for the drop detector.

### PARTS LIST

10 light source
11 collimating lens
12 detector
14 ejecting ports
16 ejection ports
18 ink drops
20 detection zone
22 aperture structure
24 slip
30 light source
32 light source
34 first detector
36 second detector
38 detection zone
40 second detection zone
41 aperture structures
42 ejecting ports
43 aperture structures
44 ink drops
50 aperture structure
52 detector
54 slits
56 slits
60 linear array
62 illumination bar
64 dectection zone
100 lower trace
102 two peaks
104 two peaks
110 upper trace
112 two pulses
114 two pulses
120 sub-system
121 print head
122 carriage
124 axis
126 mother board
128 cable
130 emitter
132 flex cable
134 detector
136 board
138 electrical communication

1. An ink jet printer comprising:
an ink jet print head having at least one row of a plurality of ink ejecting ports for ejecting ink droplets along a plurality of ink droplet paths, the ink jet print head residing at a first elevation;
a collimated light source and a detector each residing at a second elevation that is lower than the first elevation, the detector positioned opposite the collimated light source, the ink jet print head being movable to a test position where the at least one row of a plurality of ink ejecting ports can fire non-printing droplets, the collimated light source directing light at the detector along a light path that intersects the plurality of ink droplet paths when the print head resides in the test position; and
an aperture located in between the collimated light source and detector and proximate to the detector to limit a field of view of the detector and increase an optical signal-to-noise ratio of the detector.

2. An ink jet printer as recited in claim 1 wherein:
the light source operates in an infrared wavelength such that ink droplets of different colors provide a signal that is independent of an individual ink droplet spectral response.

3. An ink jet printer as recited in claim 1 wherein:
the light source operates in an infrared wavelength that is generally transparent to ink droplets of different colors.

4. An ink jet printer as recited in claim 1 wherein:
the collimated light source is an LED with a collimating lens.

5. An ink jet printer as recited in claim 1 wherein:
the collimated light source is a VCSEL light source.

6. An ink jet printer as recited in claim 1 wherein:
the collimated light source is a laser diode with a collimating lens.

7. An ink jet printer as recited in claim 1 wherein:
the detector is a photodiode.

8. An ink jet printer as recited in claim 1 wherein:
the detector is a phototransistor.

9. An ink jet printer as recited in claim 1 wherein:
the detector is a linear CCD array.

10. An ink jet printer as recited in claim 1 wherein:
the detector is a linear CMOS array.

11. An ink jet printer as recited in claim 1 wherein:
the detector is a two-dimensional CCD array.

12. An ink jet printer as recited in claim 1 wherein:
the detector is a two-dimensional CMOS array.

13. An ink jet printer as recited in claim 1 wherein:
the collimated light source, the detector and the aperture yield a range of signal to noise ratio of 1.5/1 to 10/1.

14. An ink jet printer as recited in claim 1 wherein:
the aperture is a slit having a width in the range of 0.1 millimeters to 2 millimeters.

15. An ink jet printer as recited in claim 1 wherein:
the aperture is a slit oriented such that the length thereof is parallel to a direction of motion of the print head.

16. An ink jet printer as recited in claim 1 wherein:
the detector and the collimated light source are fixed with respect to the printer.

17. An ink jet printer as recited in claim 1 wherein:
the detector receives light from the collimated light source along at least two light paths to allow for detection of droplet velocity.

18. An ink jet printer as recited in claim 1 further comprising:
a second collimated light source and a second detector, the second collimated light source directing light in a second light path that intersects the ink droplet paths, the second light path being parallel to the first light path.

19. An ink jet printer as recited in claim 17 wherein:
the at least two light paths are created with at least two apertures positioned adjacent to the detector.

20. An ink jet printer as recited in claim 1 further comprising:
a linear light source and a linear detection array, the linear light source directing light at the linear detection array in a second light path that intersects the ink droplet paths when the print head resides in the test position, the second light path being perpendicular to the first light path.

21. An ink jet printer as recited in claim 20 wherein:
the linear detection array is a CMOS or CCD array.

22. An ink jet printer as recited in claim 1 wherein:
signals generated by the detector are transmitted in an analog form to be converted by a signal processor of a CPU of the printer.

23. An ink jet printer as recited in claim 1 wherein:
signals generated by the detector are transmitted in an analog form to be converted by a signal processor of the printer.

24. An ink jet printer as recited in claim 23 wherein:
signals generated by the detector are converted at a rate limited to a processing speed of the signal processor of the printer.

25. An ink jet printer as recited in claim 23 wherein:
signals generated by the detector are converted at a rate that exceeds a firing rate of the ink ejecting ports.

26. An ink jet printer as recited in claim 1 wherein:
the collimated light source is mounted on a flexible circuit mounted to the printer, the printer including a capture feature for positioning the emitter to direct light along the light path and apertures to collect or restrict light.

27. An ink jet printer as recited in claim 1 wherein:
the optical signal-to-noise ratio of the detector allows detection of ink droplets having a volume of as small as about 1 picoliter.

28. An ink jet printer comprising:
an ink jet print head having at least one row of a plurality of ink ejecting ports for ejecting ink droplets toward a receiver along a plurality of ink droplet paths, the ink jet print head residing at a first elevation;
a linear detection array positioned at a second elevation lower than the first elevation and parallel to the at least one row of a plurality of ink ejecting ports; and
a linear light source positioned at the second elevation beneath and parallel to the at least one row of a plurality of ink ejecting ports, the linear light source located opposite the linear detection array, the ink jet print head capable of being moved to a test position where the at least one row of a plurality of ink ejecting ports can fire droplets, the linear light source directing light in a light path that intersects the ink droplet paths when the ink jet print head is moved to the test position.

29. An ink jet printer as recited in claim 28 further comprising:
a collimated light source and a detector each residing at the second elevation, the detector positioned opposite the collimated light source, the collimated light source directing light at the detector along a light path that intersects the plurality of ink droplet paths when the print head resides in the test position; and
an aperture located in between the collimated light source and detector and proximate to the detector to limit a field of view of the detector and increase an optical signal-to-noise ratio of the detector.

30. A method for detecting liquid droplets fired from at least one ejector, the method comprising:
positioning the ejector at a test position;
ejecting liquid droplets along at least one droplet path from the at least one ejector while the ejector is in the test position;
directing collimated light toward a detector in a light path that intersects the at least one liquid droplet path; and
restricting a field of view of the detector with an aperture proximately located to the detector thereby increasing an optical signal-to-noise ratio of the detector.

31. A method for detecting liquid droplets as recited in claim 30 wherein:
the liquid droplets are ink droplets ejected from an ink jet print head.

32. A method for detecting liquid droplets as recited in claim 30 wherein:
the optical signal-to-noise ratio of the detector allows detection of liquid droplets having a volume of as small as about 1 picoliter.

33. A method for detecting ink droplets as recited in claim 30 wherein:
dividing the field of view of the detector to receive the collimated light along at least two light paths to allow for detection of droplet velocity.
